(19) United States
(12) Patent Application Publication
(10) Pub. No.: US 2017/0359321 A1
(43) Pub. Date: Dec. 14, 2017

(54) Secure Data Exchange

(71) Applicant: Microsoft Technology Licensing, LLC, Redmond, WA (US)

(72) Inventors: Peter B. Rindal, Corvallis, OR (US); Ran Gilad-Bachrach, Bellevue, WA (US); Kim Laine, Seattle, WA (US); Michael J. Rosulek, Corvallis, OR (US); Kristin E. Lauter, La Jolla, CA (US)

(21) Appl. No.: 15/181,035

(22) Filed: Jun. 13, 2016

(51) Int. Cl. H04L 29/06; G06Q 30/08; G06F 21/60

(52) U.S. Cl. CPC H04L 63/0471; G06F 21/602; G06Q 30/08; G06Q 2220/00

(57) ABSTRACT

Techniques and architectures may be used to provide an environment where a data owner storing private encrypted data in a cloud and a data evaluator may engage in a secure function evaluation on at least a portion of the data. Neither of these involved parties is able to learn anything beyond what the parties already know and what is revealed by the function, even if the parties are actively malicious. Such an environment may be useful for business transactions, research collaborations, or mutually beneficial computations on aggregated private data.

### BACKGROUND

Cloud storage is increasingly becoming a popular way for businesses to manage their growing stockpiles of data. Security standards generally require data to be encrypted both in transit to or from the cloud, and when the data remains at rest in the cloud. Yet data at rest generally has limited value. Being able to compute on the encrypted data without having to decrypt it first would massively increase its utility. Unfortunately, computing on encrypted data may be notoriously difficult, often requiring highly sophisticated and costly cryptographic techniques such as homomorphic encryption, or other sub-optimal solutions. Currently the standard approach is to perform the computations on unencrypted data, resulting in an apparent trade-off between utility and privacy. Furthermore, users of cloud storage list security of their data as their biggest concern, and that concern is significantly amplified if the data is used for computations.

### SUMMARY

This disclosure describes techniques and architectures for providing an environment where a data owner storing private encrypted data in a cloud and a data evaluator may engage in a secure function evaluation on at least a portion of the data. Neither of these involved parties is able to learn anything beyond what the parties already know and what is revealed by the function. Techniques may include a protocol that is secure against a semi-honest cloud, malicious data owners, and evaluator, provided that the cloud does not collude with the evaluator. Such an environment may be useful for business transactions, research collaborations, or mutually beneficial computations on aggregated private data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The term “techniques,” for instance, may refer to system(s), method(s), computer-readable instructions, module(s), algorithms, hardware logic (e.g., Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs)), quantum devices, such as quantum computers or quantum annealers, and/or other technique(s) as permitted by the context above and throughout the document.

### BRIEF DESCRIPTION OF THE DRAWINGS

The detailed description is set forth with reference to the accompanying figures. In the figures, the left-most digit of a reference number identifies the figure in which the reference number first appears. The use of the same reference numbers in different figures indicates similar or identical items or features.

FIG. 1 is a block diagram depicting an environment for generating and operating a secure data exchange, according to various examples.

FIG. 2 is a block diagram depicting a device for generating and operating a secure data exchange, according to various examples.

FIG. 3 is a block diagram of a data exchange, according to various examples.

FIG. 4 is a block diagram of an example data exchange and data evaluation.

FIG. 5 is a block diagram of information transfer for a secure data exchange, according to various examples.

FIG. 6 illustrates an example semi-honest OT extension protocol.

FIG. 7 is a flow diagram illustrating a process for operating a secure data exchange, according to some examples.

### DETAILED DESCRIPTION

Techniques and architectures described herein involve a computing system, herein referred to as a secure data exchange (SDE), that allows data-level interaction among a number of entities, such as owners of data stored in a network memory such as the cloud, and consumers of such data. SDE may be implemented on server-based or network computers. In some examples, “data exchange” refers to, among other things, access of some form of data, or portion thereof, of one entity (or entities) by another entity (or entities). The access may be a part of a process for any of a number of intentions or purposes, such as a purchase or sale of the data, analysis of the data, use of the data for training of machine learning models, and so on.

In some examples, data owners may store private encrypted data in a semi-honest non-colluding cloud. Such characteristics are described below. However, other examples may involve a colluding cloud, and claimed subject matter is not limited in this respect. A data consumer may be an evaluator (e.g., a third party to the data owners and the cloud) having an intent to engage in a secure function evaluation on the data belonging to some subset of the data owners. In some implementations, none of the entities involved learns anything beyond what the entities already know and what is revealed by the function, even if the entities (except the cloud) are actively malicious. Some examples of data-level interactions may be related to business transactions, research collaborations, or mutually beneficial computations on aggregated private data. In some examples, SDE may be implemented using, at least in part, a secure multi-party computation (MPC) in a server-aided environment, as described below.

Techniques and architectures described herein involve an SDE system that, in some examples, may be considered to be a particular type of a reverse auction involving security and privacy measures. For example, an SDE system may be a secure marketplace where several sellers (e.g., data owners) have valuable data they wish to sell. The sellers may have uploaded the data in the cloud in encrypted form to put it on the “market.” A buyer (e.g., data evaluator, or simply “evaluator”) has an intent to buy data from one or more of the sellers with a stipulation that the data satisfies certain conditions. In some situations, the price the buyer would offer may depend on some particular qualities of the data, and sellers may want to only agree if the price offered is above some threshold value. In such situations, a negotiation on the value of private data may occur. In some cases, the buyer would prefer to keep the price it is willing to offer secret, and the sellers would not want to reveal their conditions for accepting or rejecting offers. In situations with more than one seller, the buyer may intend to engage in a deal with one or more particular sellers having certain criteria, such as data of the sellers being of most use to the buyer, the sellers' price being the lowest, data of the sellers having been on the market for the shortest/longest time, just to name a few examples. In some cases, a buyer may not have an intent to buy the data itself, but may instead be interested in buying (or evaluating) some limited number of bits of information about the data, such as the value of a particular function evaluated on the data. In this case, a price for this limited information may depend, at least in part, on the function and/or the bit width of a resulting output.

In some examples, a seller of data may establish a time limitation and/or a data limitation regarding the application of a mathematical operator on the data. For example, the seller may place a relatively high price for allowing inspection or analysis of the data (e.g., via the mathematical operator) for a relatively long period. Similarly, the seller may place a relatively high price for allowing inspection or analysis of a relatively large amount of the data (e.g., allowing the mathematical operator to operate on a relatively large portion of the data).

As mentioned above, SDE may be enabled using, at least in part, MPC, which may allow two or more entities to evaluate a function on their respective private inputs in such a way that one or more of the entities obtains the output of the function, but none of the entities learns anything about the other's inputs, except what may be inferred from the output of the function.

In some examples, one of the entities is a semi-honest and non-colluding cloud, which may assist in the MPC. The cloud, however, need not contribute any input of its own, or receive any output. Such a cloud may be included in a system that may be referred to as a server-aided setting. In particular, the system may incorporate a security model that maintains data privacy even if all entities except the cloud are arbitrarily malicious.

In some examples, SDE provides a number of benefits, such as allowing for long-term data storage in the cloud and allowing for repeated use of the data. Furthermore, SDE may allow for parties to receive respective private outputs. As another benefit, SDE may reduce a non-collusion condition so that non-collusion applies only between the cloud and evaluator.

In some examples, a process involving SDE itself may not specify how exactly a computation is negotiated among parties (e.g., buyer(s), seller(s)). In some cases, all participants may have an opinion about what computations are acceptable. A process may start from the assumption that the cloud garbles the circuit to determine the computation that will be performed in the MPC. But in many scenarios, the situation may be that a buyer wants to, for example, evaluate the data in a certain way, but the seller can't allow just any type of evaluation (e.g., like printing the data itself). Therefore, the seller may need to accept a certain computation before the cloud garbles it. Once the computation has been agreed upon (this may occur outside of SDE process described herein), the computation is to be communicated to the cloud. It may be that the cloud already knows the computation if the cloud is also a part of the computation selection process (for example, the cloud may refuse to garble very difficult computations). But in the end, the cloud may hold a description of the computation so that it knows what circuit to garble. In addition, in some examples, since the cloud is semi-honest, it may be assumed that the cloud will garble the circuit that it is supposed to garble and not, for example, something whose result would reveal more information to the buyer than what the seller would like. How exactly the cloud gets the computation may vary depending on the situation. The computation itself may be described by a Boolean circuit, because those are the types of functions that can be garbled.

Once the cloud has garbled the circuit, it may send the circuit to the buyer. At this point, the cloud may send wire labels corresponding to the bits of its own input values to the buyer (e.g., the cloud's input may be the encrypted data of the seller). Since the wire labels are encryptions of a sort of the bits in the wires of the Boolean circuit, the cloud may be sending doubly-encrypted data to the buyer (e.g., encrypted first by the seller using AES in counter mode, and then encrypted bit-by-bit using the garbling scheme, by choosing wire labels for each wire from which the original bits (of the encrypted data of the seller) may be impossible for anyone else except the cloud to recover). Next, the buyer may request using OT extension wire labels from the cloud for the buyer's data. Thus, the buyer requests an encryption of its own data from the cloud in such a way that the cloud does not learn the data.

The buyer may be ready to evaluate the garbled circuit since it has all of the inputs (in encrypted form, e.g., it holds the input wire labels rather than input bits). Once the garbled circuit has been evaluated by the buyer, it may hold a set of wire labels which correspond to output bits of the computation. However, the buyer does not know how these wire labels correspond to true bits 0 and 1. Only the cloud who garbled the circuit and chose the wire labels for each wire knows that information. Therefore, the cloud needs to share the decoding (or decrypting) information (e.g., how the output wire labels correspond to bits 0 and 1) with the buyer. In cases where also some sellers receive output, the buyer has to first share the wire labels corresponding to the sellers' output with them, after which the cloud needs to share the decoding (or decrypting) information with the sellers. All these parties can match the wire labels to the true output bits 0 and 1. The sellers need to be sure that the buyer shares the correct wire labels with them and that the buyer does not just come up with some random strings that it claims are the sellers' output wire labels. Once the sellers are convinced that they have the correct output wire labels from the buyer, the cloud shares the decoding information with all parties. Otherwise it could be that the cloud shares the decoding information with all parties so the buyer receives the cloud's true output. But if the buyer gave bogus wire labels to the sellers, there may be no way for the buyer to recover their true output as a consequence unless at a later time, perhaps after some action outside processes described herein, the buyer would share the true output wire labels with the sellers.

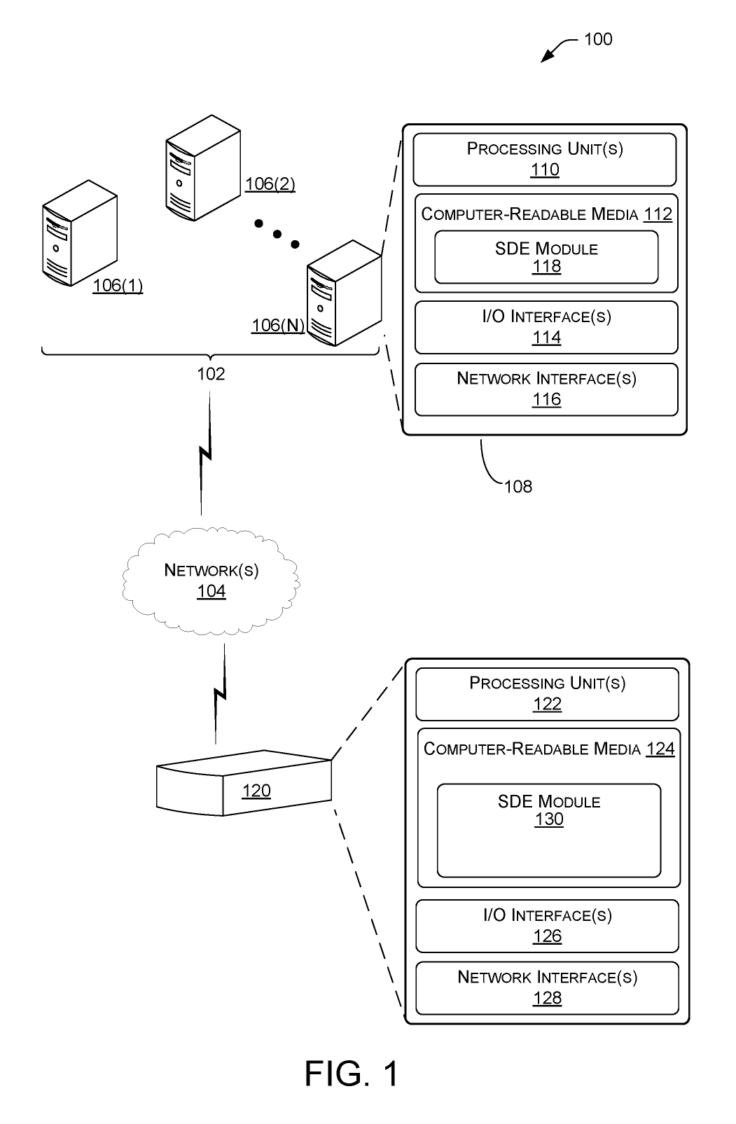

Various examples are described further with reference to FIGS. 1-7.

FIG. 1 is a block diagram depicting an environment 100 for generating and operating a secure data exchange (SDE), according to various examples. In some examples, the various devices and/or components of environment 100 include distributed computing resources 102 that may communicate with one another and with external devices via one or more networks 104.

For example, network(s) 104 may include public networks such as the Internet, private networks such as an institutional and/or personal intranet, or some combination of private and public networks. Network(s) 104 may also include any type of wired and/or wireless network, including but not limited to local area networks (LANs), wide area networks (WANs), satellite networks, cable networks, Wi-Fi networks, WiMax networks, mobile communications networks (e.g., 3G, 4G, 5G, and so forth) or any combination thereof. Network(s) 104 may utilize communications protocols, including packet-based and/or datagram-based protocols such as internet protocol (IP), transmission control protocol (TCP), user datagram protocol (UDP), or other types of protocols. Moreover, network(s) 104 may also include a number of devices that facilitate network communications and/or form a hardware basis for the networks, such as switches, routers, gateways, access points, firewalls, base stations, repeaters, backbone devices, and the like.

In some examples, network(s) 104 may further include devices that enable connection to a wireless network, such as a wireless access point (WAP). Examples support connectivity through WAPs that send and receive data over various electromagnetic frequencies (e.g., radio frequencies), including WAPs that support Institute of Electrical and Electronics Engineers (IEEE) 1302.11 standards (e.g., 1302.11g, 1302.11n, and so forth), and other standards. Network(s) 104 may also include network memory, which may be located in a cloud, for example. Such a cloud may be configured to perform actions based on executable code, such as in cloud computing, for example.

In various examples, distributed computing resource(s) 102 includes computing devices such as devices 106(1)-106(N). Examples support scenarios where device(s) 106 may include one or more computing devices that operate in a cluster or other grouped configuration to share resources, balance load, increase performance, provide fail-over support or redundancy, or for other purposes. Although illustrated as desktop computers, device(s) 106 may include a diverse variety of device types and are not limited to any particular type of device. Device(s) 106 may include specialized computing device(s) 108.

For example, device(s) 106 may include any type of computing device, including a device that performs cloud data storage and/or cloud computing, having one or more processing unit(s) 110 operably connected to computer-readable media 112, I/O interfaces(s) 114, and network interface(s) 116. Computer-readable media 112 may have a SDE module 118 stored thereon. For example, SDE module 118 may comprise computer-readable code that, when executed by processing unit(s) 110, generate and operate an SDE. In some cases, however, an SDE module need not be present in specialized computing device(s) 108.

A specialized computing device(s) 120, which may communicate with device(s) 106 (including network storage, such as a cloud memory/computing) via networks(s) 104, may include any type of computing device having one or more processing unit(s) 122 operably connected to computer-readable media 124, I/O interface(s) 126, and network interface(s) 128. Computer-readable media 124 may have a specialized computing device-side SDE module 130 stored thereon. For example, similar to or the same as SDE module 118, SDE module 130 may comprise computer-readable code that, when executed by processing unit(s) 122, generate and operate an SDE. In some cases, however, an SDE module need not be present in specialized computing device(s) 120. For example, such an SDE module may be located in network(s) 104.

In some examples, any of device(s) 106 may be entities corresponding to sellers or presenters of data, buyers or evaluators of data, or a network data storage and/or computing device such as a cloud.

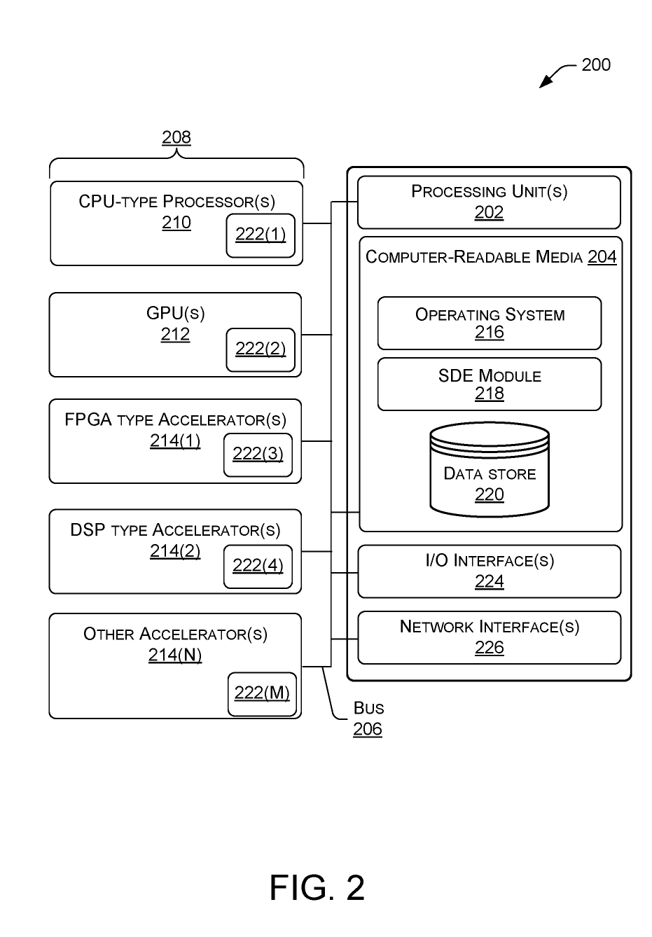

FIG. 2 depicts an illustrative device 200, which may represent device(s) 106 or 108, for example. Illustrative device 200 may include any type of computing device having one or more processing unit(s) 202, such as processing unit(s) 110 or 122, operably connected to computer-readable media 204, such as computer-readable media 112 or 124. The connection may be via a bus 206, which in some instances may include one or more of a system bus, a data bus, an address bus, a PCI bus, a Mini-PCI bus, and any variety of local, peripheral, and/or independent buses, or via another operable connection. Processing unit(s) 202 may represent, for example, a CPU incorporated in device 200. The processing unit(s) 202 may similarly be operably connected to computer-readable media 204.

The computer-readable media 204 may include, at least, two types of computer-readable media, namely computer storage media and communication media. Computer storage media may include volatile and non-volatile machine-readable, removable, and non-removable media implemented in any method or technology for storage of information (in compressed or uncompressed form), such as computer (or other electronic device) readable instructions, data structures, program modules, or other data to perform processes or methods described herein. Computer storage media include, but are not limited to hard drives, floppy diskettes, optical disks, CD-ROMs. DVDs, read-only memories (ROMs), random access memories (RAMs), EPROMs, EEPROMs, flash memory, magnetic or optical cards, solid-state memory devices, or other types of media/machine-readable medium suitable for storing electronic instructions.

In contrast, communication media may embody computer-readable instructions, data structures, program modules, or other data in a modulated data signal, such as a carrier wave, or other transmission mechanism. As defined herein, computer storage media does not include communication media.

Device 200 may include, but is not limited to, desktop computers, server computers, web-server computers, personal computers, mobile computers, laptop computers, tablet computers, wearable computers, implanted computing devices, telecommunication devices, automotive computers, network enabled televisions, thin clients, terminals, personal data assistants (PDAs), game consoles, gaming devices, work stations, media players, personal video recorders (PVRs), set-top boxes, cameras, integrated components for inclusion in a computing device, appliances, or any other sort of computing device such as one or more separate processor device(s) 208, such as CPU-type processors (e.g., micro-processors) 210, GPUs 212, or accelerator device(s) 214.

In some examples, as shown regarding device 200, computer-readable media 204 may store instructions executable by the processing unit(s) 202, which may represent a CPU incorporated in device 200. Computer-readable media 204 may also store instructions executable by an external CPU-type processor 210, executable by a GPU 212, and/or executable by an accelerator 214, such as an FPGA type accelerator 214(1), a DSP type accelerator 214(2), or any internal or external accelerator 214(N).

Executable instructions stored on computer-readable media 202 may include, for example, an operating system 216, a SDE module 218, and other modules, programs, or applications that may be loadable and executable by processing units(s) 202, and/or 210. For example, SDE module 218 may comprise computer-readable code that, when executed by processing unit(s) 202, generate and operate an SDE. In some cases, however, an SDE module need not be present in device 200.

Alternatively, or in addition, the functionally described herein may be performed by one or more hardware logic components such as accelerators 214. For example, and without limitation, illustrative types of hardware logic components that may be used include Field-programmable Gate Arrays (FPGAs), Application-specific Integrated Circuits (ASICs), Application-specific Standard Products (ASSPs), quantum devices, such as quantum computers or quantum annealers, System-on-a-chip systems (SOCs), Complex Programmable Logic Devices (CPLDs), etc. For example, accelerator 214(N) may represent a hybrid device, such as one that includes a CPU core embedded in an FPGA fabric.

In the illustrated example, computer-readable media 204 also includes a data store 220. In some examples, data store 220 includes data storage such as a database, data warehouse, or other type of structured or unstructured data storage. In some examples, data store 220 includes a relational database with one or more tables, indices, stored procedures, and so forth to enable data access. Data store 220 may store data for the operations of processes, applications, components, and/or modules stored in computer-readable media 204 and/or executed by processor(s) 202 and/or 210, and/or accelerator(s) 214. For example, data store 220 may store version data, iteration data, clock data, private data, one or more (math) functions or operators used for evaluating private data of external entities (e.g., sellers of the private data), and various state data stored and accessible by SDE module 218. Alternately, some or all of the above-referenced data may be stored on separate memories 222 such as a memory 222(1) on board CPU type processor 210 (e.g., microprocessor(s)), memory 222(2) on board GPU 212, memory 222(3) on board FPGA type accelerator 214(1), memory 222(4) on board DSP type accelerator 214(2), and/or memory 222(M) on board another accelerator 214(N).

Device 200 may further include one or more input/output (I/O) interface(s) 224, such as I/O interface(s) 114 or 126, to allow device 200 to communicate with input/output devices such as user input devices including peripheral input devices (e.g., a keyboard, a mouse, a pen, a game controller, a voice input device, a touch input device, a gestural input device, and the like) and/or output devices including peripheral output devices (e.g., a display, a printer, audio speakers, a haptic output, and the like). Device 200 may also include one or more network interface(s) 226, such as network interface(s) 116 or 128, to enable communications between computing device 200 and other networked devices such as other device 120 over network(s) 104 and network storage, such as a cloud network. Such network interface(s) 226 may include one or more network interface controllers (NICs) or other types of transceiver devices to send and receive communications over a network.

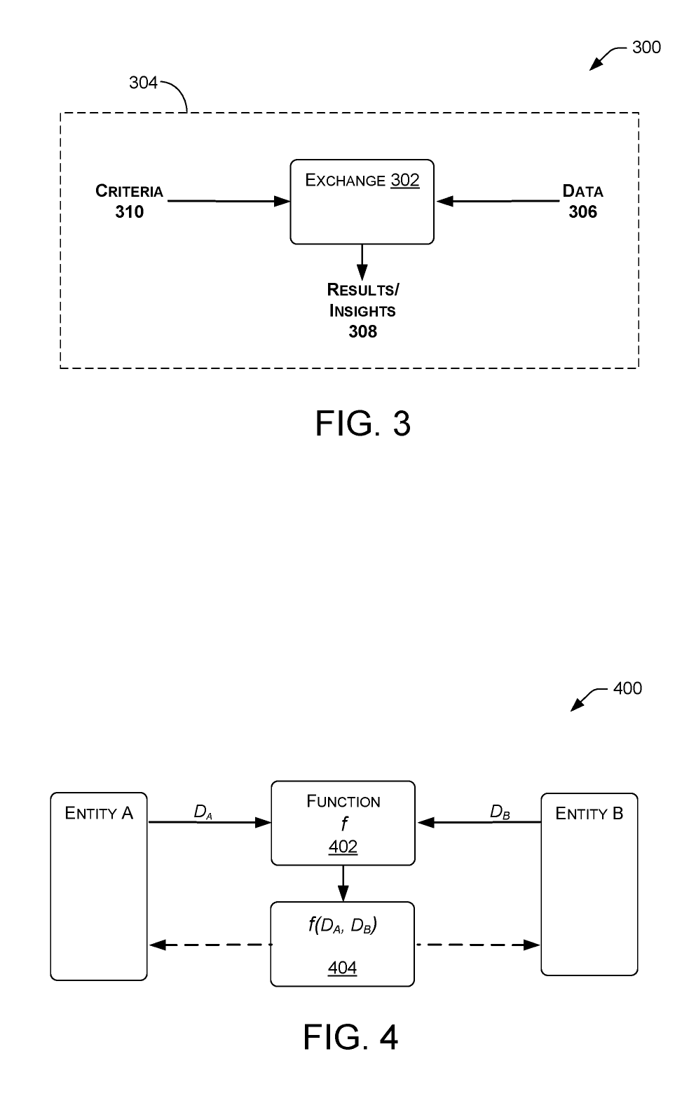

FIG. 3 is a block diagram of an example environment 300 for a data exchange 302, which may occur in an SDE 304. To name a few examples, such an exchange of data 306 may involve a sale/purchase of the data, evaluation of the data, use of the data for machine learning, and so on. Such an exchange of data 306 may lead to any of a number of results and/or insights 308. For example, criteria 310 applied to the evaluation of data 306 by exchange 302 may lead to a determination of the value (e.g., monetary and/or usefulness) of the data.

Exchange 302 may receive data from any of a number of sources or entities, such as data owners that store their data in a cloud or other network memory. Herein data “owners” of data may refer to an entity that controls the data. Such control may include: selecting how, where, and how long to store the data; whether to sell the data; whether to append or change the data, and so on. Such data may be encrypted before being received by exchange 302. Criteria provided to exchange 302 may include a set of rules (e.g., mathematical or logical) to be applied to the data or a portion thereof. For example, criteria may comprise a mathematical function or operator.

FIG. 4 is a block diagram of an environment 400 that supports a data exchange and data evaluation, according to some examples. Environment 400 may be an SDE, which may be implemented by computing resources 102 and one or more networks 104 of environment 100, as described above, for example. Though two entities, entity A and entity B, are illustrated, environment 400 may include any number of entities.

An exchange of data may occur in block 402, where a function ƒ may be applied to data from Entities A and B. In particular, Entity A may provide data D_{A} to block 402 and Entity B may provide data D_{B} to block 402. Generally, data D_{A} and/or data D_{B} may comprise any of a number of forms of data (e.g., bits representing numerical values, text, images, video, audio, and so on) or one or more functions or operators. Thus, for example, Entity B may provide function ƒ (e.g., a set of mathematical or logical rules) to block 402 and Entity A may provide data to block 402, which may apply function ƒ to the data or a portion thereof. Such an application of the function on the data may lead to a result ƒ(D_{A}, D_{B}), illustrated in block 404. This result may be provided to one or more of Entities A and B. In some examples, the result, or a portion thereof, may, by design, be concealed from either of Entities A and B. Such concealing may be implemented using encryption techniques, as described below.

In various examples, environment 400 may leverage an existing cloud storage infrastructure. Cloud service providers may generally be equipped to store data of their customers, so that data may either remain stored in its existing form, or in some “reasonable” form that causes little or no extra overhead in cloud storage costs. An example of an “unreasonable” form of storing data may involve encoding/encryption that is, say, a hundred times larger than the corresponding plaintext data. Whether encrypted or unencrypted, data in the cloud may be persistent in the sense that the data may be stored for an arbitrarily long period of time, and the data may be updatable so that owners or managers of the data may easily append to the data, or may ask the cloud to delete parts of the data.

In various examples, environment 400 may align with existing incentives for cloud services. For example, users (e.g., data owners or managers) may store their data in the cloud to avoid managing their own storage solutions onsite and to benefit from collective economies of scale. Environment 400 may allow that data to be reusable for many computations with different parties. In a system for computations in the cloud, there may be one entity (e.g., Entities A or B) with the majority of interest in the outcome of a computation or evaluation. That entity, along with the cloud provider, may be willing to expend significant effort to carry out computations or evaluations with a cryptographic security guarantee. Other entities, whose data may be involved in the computation, need only have relatively little involvement in the computation, for example.

In various examples, environment 400 may use trust models that reflect a current reality of cloud services. For example, users of cloud storage may place a limited amount of trust in cloud service providers. Sensitive data may be encrypted by a user before being stored in the cloud. Such an action may be taken in view of the cloud provider being considered “semi-honest,” which may be a condition or characteristic of the cloud. For example, semi-honest adversaries generally follow a protocol but attempt to learn more than their intended share of information by looking at the protocol execution. Other characteristics of a cloud include “malicious” adversaries, which may (be “actively malicious” and) try to attack the protocol by basically any of a number of techniques. The cloud is “non-colluding” if the messages the cloud sends to other entities reveal no information about the cloud's input other than what can be learned from the output of the function. In the case of a semi-honest cloud, environment 400 may leverage the corresponding limited trust in the cloud provider to reduce the cost of computations.

For example, a SDE process performed in environment 400 may allow an arbitrary number of data owners (e.g., Entity A) to store data in encrypted form to a cloud service in a persistent and updatable manner, and allow a third party (e.g., an evaluator, which may be Entity B) to compute a function ƒ on the data, as in block 402. The result of applying the function may be shared with any subset of the entities involved, and none of the entities will learn anything about the data beyond what they already know and what will be revealed by the function. On the other hand, the cloud may learn nothing. The data stored in the cloud may be used repeatedly for an arbitrary number of such interactions. Moreover, the SDE process performed in environment 400 may remain secure in the presence of malicious data owners and/or a malicious evaluator, as long as the cloud remains semi-honest and does not collude with the evaluator.

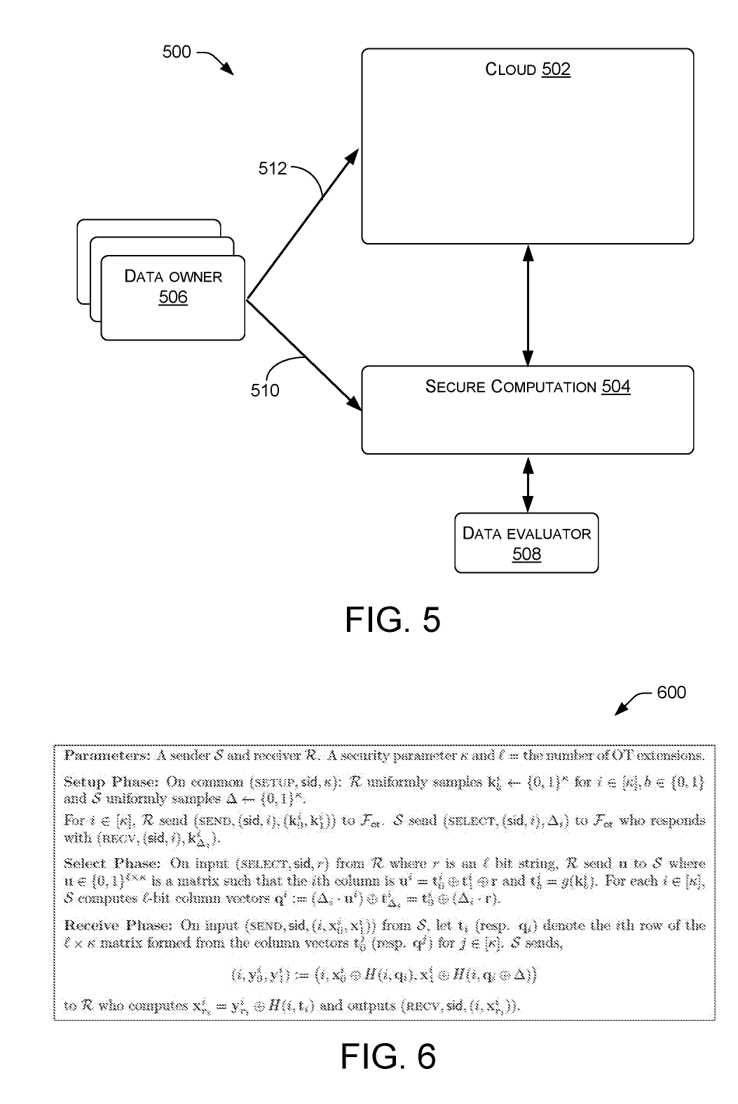

FIG. 5 is a block diagram of information transfer for a secure data exchange in a system 500, according to various examples. Such information may include data, operators or functions, instructions (e.g., logic), and encryption keys, among other things. In some examples, a substantial part of the SDE may be implemented by the cloud 502 and secure computation block 504. System 500 may further include one or more data owners 506, which may own or manage data and provide the data for storage in cloud 502. Data owners 506 may be the same as or similar to Entity A described for FIG. 4, for example. System 500 may also include a data evaluator 508, herein called “evaluator”, which may own or manage an operator or function, herein called “function”, that may be applied to the data stored in cloud 502. Evaluator 508 may provide the function to secure computation block 504, which may apply the function to the data. Evaluator 508 may be the same as or similar to Entity B described for FIG. 4, for example. In some examples, data owner(s) may provide an encryption key to secure computation block 504, as indicated by arrow 510. Data owner(s) may also provide the encryption key to cloud 502, as indicated by arrow 512.

An SDE operated in system 500 may be used for any of a number of data-consumption cases. In a particular example, a pharmaceutical company, which may be a data evaluator 508, intends to purchase anonymized patient medical records from several hospitals, which may be data owners 506, for research purposes. Since the price of such medical data is typically very high, the pharmaceutical company would like to have a certain confidence in the quality and usefulness of the data before agreeing to purchase the data. The sellers of the data, however, may not be willing to share the data with the buyer before a deal has been agreed upon. Also, the data may not be as interesting as originally thought, so the buyer may agree to purchase the data at a lower-than-expected price. A negotiation between the buyer and the seller for data access and/or price may be difficult without the seller sharing precise information about the data. One solution may be for the seller to agree to compute certain statistics on the data, but this generally provides too low of a resolution for the buyer to make a truly informed decision.

To address such potential difficulties for a data transaction between buyer and seller, an SDE in system 500 may allow the pharmaceutical company (e.g., the data owner) and the buyer (e.g., the data evaluator) to engage in a secure function evaluation on at least a portion of the data. Neither of these involved parties would be able to learn anything beyond what the parties already know and what is revealed by the function, even if the parties are actively malicious.

In another particular example, a medical center, which may be a data evaluator 508, intends to compare the expected outcome of its treatment plan for pneumonia with the expected outcomes of the treatment plans used at competing medical centers, which may be data owners 506. The problem is that the medical centers do not wish to publicly disclose such information for fear of being called out for providing less effective care. To address such potential difficulties for data privacy, an SDE in system 500 may allow the medical center to evaluate at least a portion of the data without other involved parties being able to learn anything beyond what the parties already know and what is revealed by the evaluation.

In still another particular example, a company, which may be a data evaluator 508, is developing machine learning models for assisting primary care providers in choosing the desirable treatment plans for their patients for a variety of situations. The company would like to buy anonymized patient medical records data from hospitals, which may be data owners 506, to further develop and study their models, but only if the data does not already fit the model sufficiently well. To address potential difficulties in determining quality or usefulness of data, an SDE in system 500 may allow the data to be evaluated without the company or the hospitals being able to learn anything beyond what these parties already know and what is revealed by the evaluation.

In still another particular example, a company, which may be a data evaluator 508, producing chocolate bars intends to learn detailed information about the chocolate bar market (e.g., market elasticity) by combining its own data with the data of other companies, which may be data owners 506, in the same or related market. Its goal would be to reduce costs through improved efficiency and better pricing, but the other companies are not willing to share their private financial data. To address potential difficulties for proprietary data privacy, an SDE in system 500 may allow the data to be evaluated without any of the companies being able to learn anything beyond what these parties already know and what is revealed by the evaluation.

For the examples described above, an SDE in system 500 may help to avoid substantial and costly litigation intended to preserve the interests of each involved party, while preserving privacy. In some scenarios, anonymization procedures, which may be used in lieu of an SDE, for example, may undesirably lead to the resolution of the data decreasing enough to where a significant part of the data's value is lost in the process.

To describe some examples of an SDE implementation, parties (e.g., entities) involved are denoted as C (cloud), P₁, . . . , Pₙ (data owners), and Q (a third party/function evaluator). The input data of a party Pᵢ is denoted by xᵢ and any input data of Q is denoted by x_{Q}. It is also possible for Pᵢ to have per computation inputs analogous to x_{Q}. For example, in an SDE model, the data owners Pᵢ store their data in the cloud C long-term in encrypted form. Such data can be used repeatedly in several SDE executions. In contrast, some MPC techniques do not allow such a setup. Instead, the encrypted inputs in such MPC protocols can be used only for one MPC execution, making cloud storage much less meaningful. Thus the long-term encrypted cloud storage that the SDE implementation described herein is an advantage over some MPC techniques. It is also possible, in the SDE implementation described herein, for the data owners to have a part of their data unencrypted in the cloud and, in the secure function evaluation, encrypted and unencrypted data can be combined. It is also possible that, in the SDE implementation described herein, in addition to the data stored in the cloud, the data owners Pᵢ have some “per computation input”, which they provide to the secure computation either via the server or by handing it to the evaluator. This per computation input can be hidden from C and/or Q. This is analogous to the input of Q, which is also not stored in the cloud.

Each Pᵢ may encrypt their data xᵢ prior to uploading it to C for long term storage. Pᵢ may uniformly sample the key rᵣ←{0,1}^{κ} and compute zᵢ:=xᵢ·g(rᵢ), where g is a pseudo-random function (PRF) that all parties have agreed to use, and the symbol “·” indicates a XOR operation. Then each Pᵢ may send zᵢ to C.

If a party Q wishes to initiate an SDE computation with some subset of the parties Pᵢ, party Q may ask those particular Pᵢ for their respective seeds rᵢ. After all involved parties have agreed on a function ƒ(x₁, . . . , xₙ, x_{Q}) to be computed, C and Q may engage in a two-party MPC protocol where the private input of C is the set of the zᵢ and the private input of Q is the set of the g(rᵢ) and Q's own private data x_{Q}. Secret shares zᵢ and g(rᵢ) may be reconstructed inside the MPC, resulting in xᵢ. Due to xᵢ now being MPC-encrypted, the reconstruction need not reveal any information to either party. The MPC-encrypted data xᵢ may then be passed on as input to the function ƒ within the MPC. As a result, Q (and possibly some of the parties Pᵢ) may obtain the output of (x₁, . . . , xₙ, x_{Q}) in encrypted form, and C may finish the protocol by distributing the appropriate decryption keys. In some examples, the security of the protocol described above may be based, at least in part, on several conditions. First, the cloud C is semi-honest, and that C and Q are non-colluding, wherein C and Q follow the protocol and do not share additional information with the other parties. Colluding, for example, may allow C and Q to obtain xᵢ as soon as Pᵢ sends rᵢ to Q.

If a data owner Pⱼ attempts to send an incorrect rⱼ to Q, then g(rⱼ) would correspondingly be incorrect. In this way Pⱼ may influence their position or another party's position in the SDE setting. As such manipulation is not always detectable, Q should account for this behavior in the presence of malicious parties. Thus, a condition for SDE is that Pᵢ sends the correct rᵢ to Q. Third, because the party Q may flip any of the bits of the g(rᵢ) to influence the different parties' positions in the SDE setting, a condition for SDE is that Q uses the correct g(rᵢ) as its inputs to the MPC. Such conditions are realistic in many scenarios where all of the parties are willing to engage in a business deal.

In some examples, a semi-honest SDE protocol (e.g., an intermediate protocol, which may be secure when all of the parties are semi-honest and non-colluding) may be secure against semi-honest adversaries, or have a stronger security model that is secure against C being semi-honest and non-colluding with respect to Q, and Pᵢ and Q being malicious (stronger security may result in loss of performance). In the semi-honest protocol, the party Q inputs values g(rᵢ) into an MPC computation. C may produce a “garbled circuit”, which is a type of an encryption of a Boolean circuit to be evaluated, and takes encrypted (garbled) data as input and produces an encrypted (garbled) output, for which C possesses decryption keys. The evaluation of the garbled circuit may be performed by the party Q. To be able to perform the evaluation, Q obtains the garbled inputs of C (garblings of zᵢ), and garblings of its own inputs g(rᵢ) and x_{Q} without revealing anything to C. To do this, Q may engage in oblivious transfer (OT) or some type of OT extension protocol with C. OT allows Q to get the correct encryptions from C for its input g(rᵢ) and x_{Q}. For example, if the input of Q is just one bit, 0 or 1, C holds two “labels”, or encryptions, for this particular input bit, one of which corresponds to an input value of 0 and the other one to an input value of 1 (this is specific to the garbled circuit MPC technique, but could be different using other MPC techniques). Due to how certain garbled circuit optimizations work, it is essential that Q does not learn both labels. To preserve the privacy of Q, C should not be able to learn whether Q's input bit is 0 or 1, so Q may not simply ask C to send the correct label. This example refers to a problem that OT solves. Note that OT may be relatively slow and naively it may seem like one OT would need to be performed for EACH input bit of Q. Such a situation may be unreasonably slow in most cases. Instead, a technique called “OT extension” may be used. Instead of performing many OTs, it may be possible to perform just a few and in a certain fashion “extend” them to yield a larger number of OTs (for each input bit eventually). To do this, Q may engage in oblivious transfer (OT).”

In some examples, Pᵢ may intend to force Q to request the garblings of the correct bit string g(rᵢ) from C. In an offline phase, Pᵢ may commit to the OT extension protocol messages that the receiver would send in a normal execution. In the online phase, Q may then complete the OT extension protocol on behalf of Pᵢ. The cloud C may ensure that the correct messages are received by comparing the messages to the commitments. The Pᵢ may select random rᵢ and upload their data to C encrypted as zᵢ:=xᵢ·g(rᵢ). In addition, Pᵢ may perform a modified OT extension protocol, as outlined above. If a party Q initiates an SDE computation, each Pᵢ involved may send Q the seed rᵢ and the random coins that were used in the OT extension. Pᵢ may also notify C of their involvement in the MPC and may authorize their data to be used in the computation of an agreed upon ƒ. C and Q may then complete the OT extension protocol with Q acting on behalf of Pᵢ as OT receiver. Subsequently, Q may evaluate the garbled circuit computing ƒ and distribute the garbled output to C. Again, the above-described process may rely on conditions where C is semi-honest, and that Q and C are non-colluding. Accordingly, if Pᵢ sends an incorrect rᵢ to Q (e.g., after having committed to the input string g(rᵢ)), any output resulting from xᵢ will likely fail to decrypt and may be detected. Also, as a result of Pᵢ commitments to the OT messages, Q can only learn the garbled inputs that are specified by Pᵢ.

In some examples regarding output fairness of a semi-honest protocol, a malicious party cannot create a situation where only some of the participants get their (correct) output, and others don't. The situation should be that all participants get their correct output, or no participants get anything. In some implementations, a portion of the protocol may deal with this situation after the MPC Q distributes all participants' garbled outputs. For example, since Q will only know one garbled output label for each output wire, Q either sends the correct output label to a party Pᵢ, or an incorrect string of bits that is not a wire label. This makes it possible for the Pᵢ to then use some type of a verification scheme with C to check that they indeed received valid garbled outputs (e.g., C may simply send Pᵢ both of the output wire labels for each of Pᵢ's output bits, who can then check that the label they received from Q is one of them, but this process is relatively inefficient and there are better ways of doing this). After each Pᵢ has confirmed to C that they received valid/right output labels from Q, C may distribute the decrypting information needed to recover the true output bits from the output wire labels. Now all participants either get their correct outputs, or no participants get anything. Again, it is assumed here that C is semi-honest (e.g., follows the protocol).

In some cases Pᵢ may want to use several keys rᵢ for their data. For example, if the data is very large Pᵢ may not want to reveal the key to everything to Q and instead reveal the key to those parts that a particular computation needs to touch. For example, Pᵢ may use one r{i,1} for one of the files in their data, or for the first column in their dataset, another r{i,2} for the next one, and so on. Pᵢ may reveal the r{i,j} to Q which are needed in the computation. This makes it also easier for Pᵢ to update some of their keys when they want to, and not have to re-encrypt the entire data in C (which may have a large networking cost).

The commitment to Pᵢ's input that Pᵢ sends to Q can also be partitioned into blocks. This has an advantage in that C does not need to check a commitment to the entire input data of Pᵢ when Q is trying to complete the OT extension protocol. Instead, C may check a commitment to those parts that are actually used in the computation. This has the advantage in that computations that need to only touch a small amount of the data of Pᵢ become significantly easier to perform. The reason is that when completing the OT extension protocol, Q may need to send (size-of-input-data)*128 bits of data to C, for example. Q may then verify the commitment(s), but if there is only one commitment then (size-of-input-data) is the size of the entire g(rᵢ), which can be very large. Instead, commitments to smaller chunks such as the g(r{i,j}) are made, if only a few of them need to be accessed in the computation.

In some examples, after the Pᵢ upload their data to C, Pᵢ may engage in a constant amount of communication with Q, except at the end of the process, when the process (e.g., protocol) has finished running and possibly some parts of the output of the function are distributed to the parties Pᵢ. Moreover, changes to data transferred during the process may add only a relatively small amount (e.g., compared to the size of the garbled circuit) of overhead to the communication between C and Q.

In some examples, garbled circuits may allow two parties with respective private inputs x and y to jointly compute a possibly probabilistic functionality

ƒ(x,y)=(ƒ₁(x,y),ƒ₂(x,y)), Eqn. (1)

such that the first party learns ƒ₁(x, y) and the second party learns ƒ₂(x, y). Garbled circuits have become fundamental building blocks in many cryptographic protocols in recent years for two-party secure function evaluation and other multi-party protocols. A condition for security may be that no more information is learned by either party beyond their prescribed output (privacy) and that the output distribution follows what is specified by ƒ(correctness).

The garbled circuits construction may be considered to be a compiler that takes a functionality ƒ as input and outputs a secure protocol for computing ƒ. First, the functionality may be expressed as a Boolean circuit C consisting of gates (typically AND and XOR gates). Each gate g takes two logical bits a, bε{0,1} as inputs and returns a logical bit c:=g (a, b) as output. The secure protocol may then evaluate each gate of the circuit C such that it hides the logical values in all internal wires and allow for some mechanism to decode the garbled output wires.

The first party, considered to be the garbler, may generate the garbled wires and the garbled gates. The other party, considered to be the evaluator, may obtain the garbled wire labels from the garbler for the evaluator's respective input. To ensure the privacy of the evaluator's input, this process may be performed without revealing to the garbler which labels the evaluator picks. In addition, the evaluator may be prevented from evaluating the garbled circuit on several inputs, so for each garbled wire the evaluator may be allowed to learn precisely one of the two labels. This is achieved using OT. Once the evaluator has learned the input wire labels for a garbled gate, exactly one garbled output wire label may be learned. A garbled circuit is the collection of all the garbled gates and may be evaluated with an input encoding (e.g., one label per wire). The above process may then be repeatedly applied to each gate of the garbled circuit.

By the security of the garbled gate construction, the evaluator may learn exactly one of the two output wire labels C₀, C₁, while the other one of the two output wire labels remains entirely unknown. Use of malicious secure OT may then yield a protocol that is secure against a malicious evaluator who may arbitrarily deviate from the protocol. However, the garbler may maliciously construct a garbled gate or an entire circuit that computes the wrong logic. The evaluator may not be able to detect such malicious behavior, and all security properties of the construction may be lost. One technique for overcoming this issue is known as “cut-and-choose,” where the garbler generates several garbled circuits and sends them to the evaluator. The evaluator may randomly check some of the garbled circuits for correctness, and if all turn out to be honestly generated the evaluator, the evaluator may evaluate the remaining garbled circuits. Due to significant overhead incurred in sending garbled circuits, in some examples described herein, the use of cut-and-choose is avoided and a condition is applied where the garbler is semi-honest and garbles the correct circuit. In particular, the cloud C may take the role of garbler and receive no output, for example.

OT is a fundamental primitive in cryptography, and may be applied to sending garbled wire labels. For example, a sender S has two input strings x₀ and xᵢ of length l, and a receiver R has a selection bit bε{0,1}. R wants to obtain x_{b} from S in an oblivious way, meaning that S does not learn b, and R is guaranteed to obtain only x_{b} and learns no information about x_{1-b}.

The following protocol describes an ideal functionality for the oblivious transfer primitive:
Parameters: A sender S and receiver R.
Main Phase: On input (SELECT, sid, b) from R and (SEND, sid, (x₀, x₁)) from
S, send R (RECV, sid, x_{b}).

While one round of OT is fairly efficient to perform, the OT may require public-key primitives and as such may not be practical for exchanging very large amounts of information. For example, if the bit-length of the evaluator's input is l and each wire label has length κ (typically κ=128 and the labels are AES blocks), the evaluator may engage in l OTs with the garbler. This may be problematic if l is large, so a technique called “OT extension” may efficiently extend κ so-called base OTs into l OTs. More precisely, instead of having to perform l OTs of length κ, it may be sufficient to perform κ OTs of length κ.

Let {(x₀ⁱ, x₁ⁱ)}, for i=1, . . . , l be pairs of κ-bit messages that S wants to obliviously transfer to R. In other words, R has an κ-bit selection string r:=(r₁, . . . , rₗ) and R intends to obtain the messages xⁱᵣᵢ in an oblivious way. FIG. 6 illustrates an example semi-honest OT extension protocol 600.

In some examples, OT extension protocol 600 may be used to counter an active (malicious) R. The amount of communication between R and S in steps of OT extension protocol 600 may be described as follows. In the Setup Phase, a relatively small amount of OT communication between R and S may occur. κ may be set to 128 in some examples. In the Select and Receive Phases, a relatively large amount of communication may occur between R and S. For example, matrices of size l×κ may be sent between R and S, where l can potentially be very large.

In various examples, as mentioned above, C and Q are non-colluding. The parties involved are P₁, . . . , Pₙ, where each Pᵢ holds persistent input data xᵢ that is stored in the cloud C, and Q acts as the circuit evaluator and holds input data x_{Q}. The parties anticipate that some subset {Pᵢ|iεI} of the parties will perform a cloud-assisted private computation with Q over their datasets at some later point in time. In an offline phase, each party Pᵢ samples rᵢ←{0,1}^{κ} uniformly at random, and uploads their dataset xᵢ encrypted as zᵢ:=xᵢ·g(rᵢ) to the cloud C, where g is a public pseudo-random function (e.g., AES in counter-mode keyed by rᵢ, where AES is a block cipher). Let I=(I₁, . . . , Iₘ) be a subset of [n]. At a later time, Q along with {Pᵢ|iεI} decide to evaluate a functionality

ƒ({xᵢ}_{iεI},x_{Q})=(ƒ₁({xᵢ}_{iεI},x_{Q}), . . . , ƒₘ({xᵢ}_{iεI},x_{Q}),ƒ_{Q}({xᵢ}_{iεI},x_{Q})) Eqn. 2

where each party Pᵢⱼ learns ƒⱼ({xᵢ}_{iεI}, x_{Q}), and Q learns ƒ_{Q}({xᵢ}_{iεI}, x_{Q}). Any additional per computation input data x′ᵢ for party Pᵢ may be expressed as being appended to the end of zᵢ and is discussed in greater detail below. The cloud C verifies that all involved parties wish to compute ƒ. Each of the parties {Pᵢ|iεI} send their values rᵢ to Q, which computes the masks g(rᵢ). A two-party secure computation may then be performed between C and Q to compute the related functionality

ƒ′({zᵢ}_{iεI},{g(rᵢ)}_{iεI},x_{Q}):=ƒ({zᵢ·g(rᵢ)}_{iεI},x_{Q}). Eqn. 3

To evaluate ƒ′ securely using MPC, the cloud C acts as the garbler and generates the garbled circuit that computes the functionality ƒ′ and sends Q the corresponding garbled gates. In the oblivious transfer phase, Q may select the input wire labels corresponding to g(rᵢ). In some implementations, an optimization is employed where C inputs the wire labels for g(rᵢ) into the OT protocol after permuting them by zᵢ. This results in Q obtaining the effective input wire labels with values xᵢ=zᵢ·g(rᵢ) with no additional overhead. In particular, C only garbles the circuit corresponding to ƒ′ and Q obliviously learns the wire labels encoding xᵢ. After evaluating the garbled circuit, Q may send to party P_{Ij} the encoding information yⱼ (e.g., the permute bits) for the garbled output corresponding to the function ƒⱼ. Q may keep the encoding information y_{Q} corresponding to the garbled output of ƒ_{Q} to itself. The cloud C may send P_{Ij}, the corresponding decoding information dⱼ that P_{Ij} uses to obtain its result ƒⱼ({xᵢ}_{iε1}, x_{Q})=dⱼ·yⱼ. The cloud C may send Q the decoding information d_{Q} that Q similarly uses to obtain its result ƒ_{Q}({xᵢ}_{iε1},x_{Q})=d_{Q}·y_{Q}.

This process may securely and privately compute ƒ({xᵢ}_{iε1}, x_{Q}) under the assumption that the parties are semi-honest, and that C and Q are non-colluding. By the security properties of garbled circuits, Q′s view of the output encoding information yⱼ may be uniformly distributed without the decoding information dⱼ. Therefore, the evaluator Q may learn nothing more than their prescribed output and the rᵢ values that data stored in the cloud is encrypted under.

To facilitate the ability for a party to update their data stored in the cloud, a party Pᵢ may append data to the end of their dataset. To append x′ᵢ, Pᵢ may compute the last |x′ᵢ| bits of value z′ᵢ:=(xᵢ∥x′ᵢ)·g(rᵢ) and send the bits to C. An update may then trivially be achieved by garbling circuits which now take x′ᵢ as the corresponding input. Furthermore, any outdated data may then be logically deleted and removed from the cloud. No portion of g(rᵢ) is repeatedly used to encrypt different x′ᵢ values, because this would leak a linear relation between the updated data. A per computation input of a party Pᵢ may be expressed as appending data to the end of x′ᵢ, which may then be deleted before the next computation.

In some examples, a malicious-secure protocol may be subject to a non-colluding assumption between the cloud and circuit evaluator. Such a protocol may be more secure against attacks as compared to attacks against the semi-honest protocol. Consider the case where party Q evaluates a circuit computing the function ƒ′, which may reconstruct the 2-out-of-2 secret shares of the logical inputs, and then evaluates ƒ. This may lead to the situation where Q can flip any set of input bits. To obtain security against malicious behavior, it may be necessary for Q to prove that Q provided the correct value for the input secret share.

If instead of secret-sharing Pᵢ's input x between C and Q, Pᵢ performs oblivious transfer with C in the setup phase and forwards the wire labels to Q at the start of each computation. While this may achieve a desired security, Pᵢ must send a relatively large amount of data for each secure computation and may not use cloud storage. In some example implementations, an OT extension may be used to achieve cloud storage for Pᵢ with minimal online interaction. OT extension may work in three phases. First, k Base OTs on k bit strings may be performed. These OTs are in the reverse direction relative to the final OT extension. That is, the cloud C may act as a receiver and Q may act as the sender with uniform messages hⁱ₀, hⁱ₁ε{0, 1}^{k} in the ith OT. The cloud C may sample sε{0,1}^{k} uniformly and selects hⁱₛᵢ, in the ith base OT.

In the second phase, the OT extension may result in n OTs where the receiver Q learns the messages index by cε{0,1}, i.e. m_{i,ci}, for iε[n]. The parties both expand the h values to be n bits by computing Tⁱ_{b}=g(hⁱ_{b}). The cloud C now holds the larger messages Tⁱₛᵢε{0,1}ⁿ. Q knows both Tⁱ₀, Tⁱ₁ but does not know which one is held by C. The OT extension receiver Q may then compute Uⁱ=Tⁱ₀·Tⁱ₁·c and sends Uⁱ to C. This is the final message sent by Q in the protocol and may commit Q to their choice of c.

In the third phase, the cloud C may compute a matrix Dε{0,1}^{n×k} where the ith column is Dⁱ=Tⁱₛᵢ·(Uⁱ·sᵢ). Let the matrix T₀ε{0,1}^{n×k} be similarly defined by taking Tⁱ₀ as its ith column vector. Then by definition, the ith row of D is Dᵢ=T_{0,i}·(cᵢ·s), where T_{0,i} is the ith row of T₀. To see this, consider the case when cᵢ=1. Then in the jth bit location of the ith row of D) there is an additional (cᵢ·sⱼ), =sⱼ additive term, and similarly when cᵢ=0 there is no additional term. The cloud C may then encrypt the ith message pair (m_{i,0}, m_{i,1}) as y_{i,0}:=m_{i,0}·H(i, Dᵢ) and y_{i,1}=m_{i,1}·H(i, Dᵢ·s) and sends the message pair to the receiver. The receiver Q may then compute m_{i,ci}=y_{i,ci}·H(Tᵢ). In some examples, this OT extension protocol may be distributed to a setting where Pᵢ chooses which messages are learned in the OT while allowing Q to be the oblivious receiver. Pᵢ choices may be defined by the first two phases, e.g., the base OT messages hⁱ₀, hⁱ₁ and the matrix U. Once the cloud C receives these protocol messages, the final OT messages that are learnable by the receiver may be fixed.

In the offline phase, Pᵢ may upload their data to the cloud as z=x·g(r). Pᵢ may perform the first two phases of the oblivious transfer extension where the OT selection string c=g(r). C may learn the matrix D where its ith row is Dᵢ=Tᵢ·(g(r)ᵢ·s). In the online phase, Pᵢ may send the seeds r and the seed used to derive the base OT messages to Q, which may regenerate U, g(r) and complete the oblivious transfer extension with C. As in the semi-honest protocol, C may permute the input wire labels that Q will use to evaluate the circuit with by z=x·g(r). This may result in Q obtaining the wire labels encoding x=z·g(r) while being oblivious to the value of x.

In some examples, after Q has evaluated a garbled circuit and obtained the garbled outputs yᵢ of all involved parties Pᵢ (and its own garbled output y_{Q}), Q may need to distribute yᵢ to Pᵢ, who then obtains the corresponding decoding information dᵢ from C to recover the actual output bits. If C sends to Pᵢ the wire labels for both logical outputs for each output bit of Pᵢ's output, and one of them is what Q sent to Pᵢ, then Pᵢ can be sure that Q indeed evaluated the circuit correctly and handed Pᵢ the correct output wire label, as Q will never be able to learn more than one of the two output labels for any output wires.

Since C would need to send Pᵢ two wire labels for each output bit, there is a possibly significant communication cost involved in this. To reduce such a cost, C may construct the output wire labels corresponding to Pᵢ's output of the garbled circuit from a PRF with a seed r^{out}ᵢ. C can send r^{out}ᵢ to Pᵢ, who can expand the PRF and obtain the output wire labels and decode the output, thus reducing the communication cost.

There may still be a possibly significant communication cost involved in Q sending the appropriate output wire labels to Pᵢ. This cost can be reduced by instead using a point-and-permute technique. Essentially, the garbling scheme will ensure that the last bits of each pair of output labels are different, so that Q only needs to send these last bits to Pᵢ (select bits), who only needs to receive from C the permutation that matches them with the correct logical output bits. The problem with simply using this approach is that it makes it very easy for Q to flip any of the bits of Pᵢ 's output. To prevent this, Q may compute the XOR of all of the wire labels corresponding to Pᵢ 's output, and send to Pᵢ. C will then send to Pᵢ the seed for the PRF to compute the entire output wire labels, as explained above, for example. Pᵢ can then compute the XOR of the appropriate labels received from C for each of its output wires, and verify that it matches the XOR received from Q. This way Pᵢ can be sure that the output bits it gets from Q are indeed the correct ones. Once all data owners have confirmed that they received valid encoded outputs from Q, the semi-honest C may distribute the decoding information, and otherwise abort the protocol execution, guaranteeing fairness. The communication cost in the output distribution and decoding process for Pᵢ is therefore K bits of communication with C and κ+|yᵢ| bits of communication with Q

In some examples, since Sᵢ may end up sharing their secret key rᵢ with each buyer, there is desirably an easy way for Sᵢ to revoke the key rᵢ and change the data stored in encrypted form by C to use a new key rᵢ′. One way to do this would be for Sᵢ to send g(rᵢ)·g(rᵢ′) to C, which computes zᵢ′:=zᵢ·(g(rᵢ)·g(rᵢ′)) to update the encryption. Unfortunately, Sᵢ may end up sending a linear amount of data to C, which may not, in some cases, be practical.

In some examples, the parties involved in SDE are sellers, S₁, . . . , Sₖ, a buyer B, and a cloud C. Let xᵢ be the data belonging to Sᵢ that is placed on the market (e.g., the data is sent to C to be stored in encrypted form). Let y be the data of B in cases where B wants to provide input to the computation. This may be the case if, for example, B intends to compare the data on the market with its own data, set bounds on offers it is ready to make, or restrict which seller (or sellers), it is willing to deal with depending on their input data, identity, sale price, or other factors.

To securely store their data in the cloud, each Sᵢ may choose a random seed rᵢ and send zᵢ:=xᵢ·g(rᵢ) to C, where g is a PRF that all the parties agree upon (e.g., AES in counter mode, keyed by rᵢ). In a particular example, all of the parties have agreed to evaluate a particular functionality ƒ({xᵢ}, y) described as a Boolean circuit to determine a match between the buyer and zero or more sellers. Each Sᵢ may send its secret key rᵢ to B as an agreement to participate in the SDE with B. If C and B were to collude, they could together decrypt the data of Sᵢ stored in C. Unfortunately, such restrictions in the security model may be unavoidable if using MPC, unless one is willing to sacrifice performance. Let ƒ′({zᵢ}, {rᵢ}, y) denote the functionality ƒ({zᵢ·g(rᵢ)}, y). In some implementations, C and B use a semi-honest protocol to securely evaluate ƒ′({zᵢ}, {rᵢ}, y) by having C act as the garbler and B as the evaluator. Based on the result, C may inform the appropriate sellers Sᵢ that a deal with B has been made.

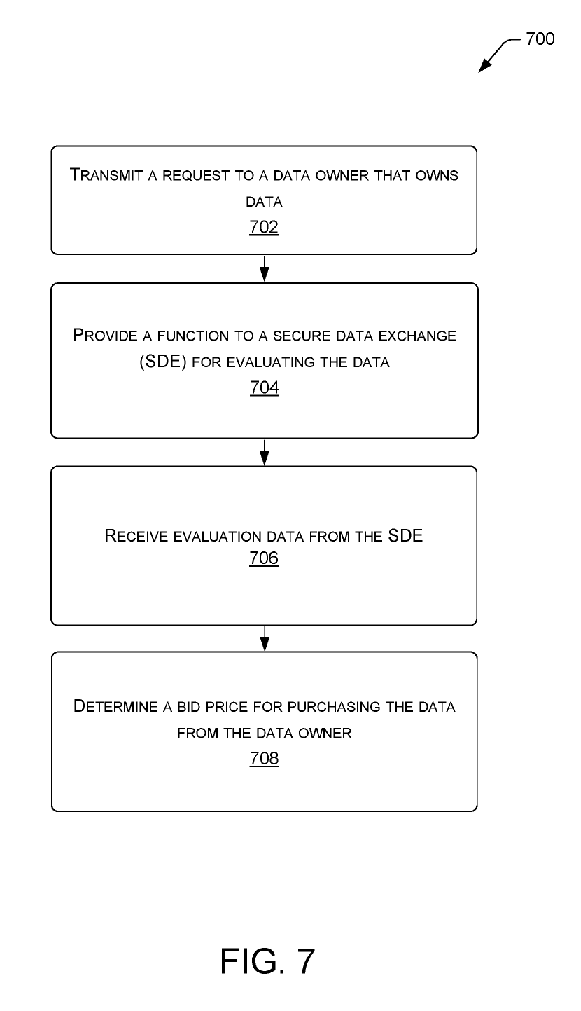

FIG. 7 is a flow diagram illustrating a process for operating a secure data exchange, according to some examples. The flows of operations illustrated in FIG. 7 are illustrated as a collection of blocks and/or arrows representing sequences of operations that can be implemented in hardware, software, firmware, or a combination thereof. The order in which the blocks are described is not intended to be construed as a limitation, and any number of the described operations can be combined in any order to implement one or more methods, or alternate methods. Additionally, individual operations may be omitted from the flow of operations without departing from the spirit and scope of the subject matter described herein. In the context of software, the blocks represent computer-readable instructions that, when executed by one or more processors, configure the processor to perform the recited operations. In the context of hardware, the blocks may represent one or more circuits (e.g., FPGAs, application specific integrated circuits—ASICs, etc.) configured to execute the recited operations.

Any process descriptions, variables, or blocks in the flows of operations illustrated in FIG. 7 may represent modules, segments, or portions of code that include one or more executable instructions for implementing specific logical functions or variables in the process.

Process 700 may be performed by a processor such as processing unit(s) 110, 122, and 202, for example. At block 702, the processor may transmit a request to a data owner that owns data. For example, the processor may be associated with an entity having an intention to purchase the data. Such data may reside in an encrypted form in a network memory, such as a cloud. At block 704, the processor may provide a function to a network-connected computing device that operates a secure data exchange for evaluating the data. The function may be a mathematical or logical relation configured to operate on the data, or a portion thereof. At block 706, the processor may receive evaluation data from the SDE. The evaluation data may be based, at least in part, on applying the function to at least a portion of the data. In other words, the evaluation data may be the output of function operating on the data. At block 708, the processor may determine a bid price for purchasing the data from the data owner. The bid price may be based, at least in part, on the evaluation data. In some implementations, for example, the evaluation data may indicate to the potential buyer how useful the data may be to the buyer. Such evaluation data provides an opportunity to “peek” at the data owner's data without direct access to the data (e.g., without inspecting the data itself. Such a situation may render a data purchase moot).

### Example Clauses

A. A system comprising: one or more processors; and computer-readable media having instructions that, when executed by the one or more processors, configure the one or more processors to perform operations comprising: receiving encrypted data from a network memory device, wherein the encrypted data is owned by a first party; receiving an encryption key from the first party; receiving a mathematical operator from a second party; and forming an encrypted version of the mathematical operator for the second party to apply to at least a portion of the encrypted data to generate evaluation data.

B. The system as paragraph A recites, wherein the encryption key received from the first party is a first encryption key, the operations further comprising: receiving a second encryption key from the second party; and corresponding to the second encryption key, encrypting the evaluation data.

C. The system as paragraph A recites, wherein the encrypted data from the network memory device is persistent data that is unmodified by the mathematical operator.

D. The system as paragraph A recites, the operations further comprising: concealing the evaluation data from the first party.

E. The system as paragraph A recites, wherein the network memory device is semi-honest and the network memory device and the second party are jointly non-colluding.

F. The system as paragraph A recites, wherein the encrypted data comprises garbled data.

G. The system as paragraph A recites, the operations further comprising: receiving instructions from the first party to place a time limitation and/or a data limitation for applying the mathematical operator to the encrypted data.

H. A method comprising: storing data as encrypted data for a data owner in a network, wherein the encrypted data is decryptable with a key; receiving a math function from a data buyer; exchanging information with the data buyer to perform the math function on at least a portion of the encrypted data to generate evaluation data; and establishing a sale value for the encrypted data based, at least in part, on the evaluation data.

I. The method as paragraph H recites, further comprising: receiving data from the data buyer; and performing the math function on (i) at least the portion of the encrypted data and (ii) the data from the buyer to generate the evaluation data.

J. The method as paragraph H recites, wherein the data is encrypted by the data owner and wherein the network does not have the key.

K. The method as paragraph H recites, wherein the math function comprises a set of logical rules provided by the data buyer.

L. The method of claim recites, wherein the encrypted data comprises garbled data.

M. The method as paragraph H recites, further comprising: further encrypting the encrypted data before performing the math function on at least a portion of the encrypted data.

N. The method as paragraph H recites, further comprising applying the evaluation data to a machine learning process.

O. The method as paragraph H recites, further comprising: providing the evaluation data to the data buyer; concealing the evaluation data from the data owner; and concealing the math function from the data owner.

P. A method comprising: transmitting a request to a data owner that owns data; providing a function to a secure data exchange (SDE) for evaluating the data; receiving evaluation data from the SDE, wherein the evaluation data is based, at least in part, on applying the function to at least a portion of the data; determining a bid price for purchasing the data from the data owner, wherein the bid price is based, at least in part, on the evaluation data.

Q. The method as paragraph P recites, wherein the data is a first set of data, the method further comprising: providing a second set of data with the function to the SDE for evaluating the first set of data, wherein the evaluation data is based, at least in part, on applying the function and the second set of data to the first set of data.

R. The method as paragraph P recites, further comprising transmitting additional requests to additional data owners that own the data.

S. The method as paragraph P recites, further comprising receiving an encryption key from the data owner before providing the function to the SDE.

T. The method as paragraph P recites, wherein the request to the data owner is transmitted through a cloud.

Although the subject matter has been described in language specific to structural features and/or methodological acts, it is to be understood that the subject matter defined in the appended claims is not necessarily limited to the specific features or acts described. Rather, the specific features and steps are disclosed as example forms of implementing the claims.

Unless otherwise noted, all of the methods and processes described above may be embodied in whole or in part by software code modules executed by one or more general purpose computers or processors. The code modules may be stored in any type of computer-readable storage medium or other computer storage device. Some or all of the methods may alternatively be implemented in whole or in part by specialized computer hardware, such as FPGAs, ASICs, etc.

Conditional language such as, among others, “can,” “could,” “may” or “may,” unless specifically stated otherwise, are understood within the context to present that certain examples include, while other examples do not include, certain features, variables and/or steps. Thus, such conditional language is not generally intended to imply that certain features, variables and/or steps are in any way required for one or more examples or that one or more examples necessarily include logic for deciding, with or without user input or prompting, whether certain features, variables and/or steps are included or are to be performed in any particular example.

Conjunctive language such as the phrase “at least one of X, Y or Z,” unless specifically stated otherwise, is to be understood to present that an item, term, etc. may be either X, Y, or Z, or a combination thereof.

Any process descriptions, variables or blocks in the flow diagrams described herein and/or depicted in the attached figures should be understood as potentially representing modules, segments, or portions of code that include one or more executable instructions for implementing specific logical functions or variables in the routine. Alternate implementations are included within the scope of the examples described herein in which variables or functions may be deleted, or executed out of order from that shown or discussed, including substantially synchronously or in reverse order, depending on the functionality involved as would be understood by those skilled in the art.

It should be emphasized that many variations and modifications may be made to the above-described examples, the variables of which are to be understood as being among other acceptable examples. All such modifications and variations are intended to be included herein within the scope of this disclosure and protected by the following claims.

What is claimed is:

1. A system comprising:
one or more processors; and
computer-readable media having instructions that, when executed by the one or more processors, configure the one or more processors to perform operations comprising:
receiving encrypted data from a network memory device, wherein the encrypted data is owned by a first party;
receiving an encryption key from the first party;
receiving a mathematical operator from a second party; and
forming an encrypted version of the mathematical operator for the second party to apply to at least a portion of the encrypted data to generate evaluation data.

2. The system of claim 1, wherein the encryption key received from the first party is a first encryption key, the operations further comprising:
receiving a second encryption key from the second party; and
corresponding to the second encryption key, encrypting the evaluation data.

3. The system of claim 1, wherein the encrypted data from the network memory device is persistent data that is unmodified by the mathematical operator.

4. The system of claim 1, the operations further comprising:
concealing the evaluation data from the first party.

5. The system of claim 1, wherein the network memory device is semi-honest and the network memory device and the second party are jointly non-colluding.

6. The system of claim 1, wherein the encrypted data comprises garbled data.

7. The system of claim 1, the operations further comprising:
receiving instructions from the first party to place a time limitation and/or a data limitation for applying the mathematical operator to the encrypted data.

8. A method comprising:
storing data as encrypted data for a data owner in a network, wherein the encrypted data is decryptable with a key;
receiving a math function from a data buyer;
exchanging information with the data buyer to perform the math function on at least a portion of the encrypted data to generate evaluation data; and
establishing a sale value for the encrypted data based, at least in part, on the evaluation data.

9. The method of claim 8, further comprising:
receiving data from the data buyer; and
performing the math function on (i) at least the portion of the encrypted data and (ii) the data from the buyer to generate the evaluation data.

10. The method of claim 8, wherein the data is encrypted by the data owner and wherein the network does not have the key.

11. The method of claim 8, wherein the math function comprises a set of logical rules provided by the data buyer.

12. The method of claim 8, wherein the encrypted data comprises garbled data.

13. The method of claim 8, further comprising:
further encrypting the encrypted data before performing the math function on at least a portion of the encrypted data.

14. The method of claim 8, further comprising applying the evaluation data to a machine learning process.

15. The method of claim 8, further comprising:
providing the evaluation data to the data buyer;
concealing the evaluation data from the data owner; and
concealing the math function from the data owner.

16. A method comprising:
transmitting a request to a data owner that owns data;
providing a function to a secure data exchange (SDE) for evaluating the data;
receiving evaluation data from the SDE, wherein the evaluation data is based, at least in part, on applying the function to at least a portion of the data;
determining a bid price for purchasing the data from the data owner, wherein the bid price is based, at least in part, on the evaluation data.

17. The method of claim 16, wherein the data is a first set of data, the method further comprising:
providing a second set of data with the function to the SDE for evaluating the first set of data, wherein the evaluation data is based, at least in part, on applying the function and the second set of data to the first set of data.

18. The method of claim 16, further comprising transmitting additional requests to additional data owners that own the data.

19. The method of claim 16, further comprising receiving an encryption key from the data owner before providing the function to the SDE.

20. The method of claim 16, wherein the request to the data owner is transmitted through a cloud.
